(19) United States
(12) Patent Application Publication
(10) Pub. No.: US 2006/0106122 A1
(43) Pub. Date: May 18, 2006

(54) Extruded polystyrene resin foam board and process for preparing the same

(75) Inventors: Masato Naito, Kanuma-shi (JP); Naochika Kogure, Kanuma-shi (JP); Teruyuki Akiyama, Kanuma-shi (JP); Akira Okuda, Kanuma-shi (JP)

Correspondence Address: OLIFF & BERRIDGE, PLC, P.O. BOX 19928, ALEXANDRIA, VA, 22320, US

(73) Assignee: JSP Corporation, Tokyo (JP)

(21) Appl. No.: 11/270,742

(22) Filed: Nov. 10, 2005

(30) Foreign Application Priority Data
Nov. 12, 2004 (JP) 2004-329106

(51) Int. Cl. C08J 9/00

(52) U.S. Cl. 521/79

(57) ABSTRACT

The present invention relates to a process for preparing an extruded polystyrene resin foam board having excellent flame retardancy and recyclability, which comprises extruding and foaming a foamable composition, the foamable composition containing a polystyrene resin, a blowing agent and a specific flame retardant including a phosphate ester and a brominated bisphenol ether compound represented by the formula shown in the specification, and to a polystyrene resin foam board having excellent flame retardancy, environmental compatibility and recyclability.

### BACKGROUND OF THE INVENTION

1. Field of the Invention

The present invention relates to an extruded polystyrene resin foam board and to a process for preparing the foam board. More specifically, the present invention is directed to an extruded polystyrene resin foam board having excellent flame retardancy and environmental compatibility and to a process which can prepare in a stable manner an extruded polystyrene resin foam board having excellent recyclability and flame retardancy. The foam board is useful as, for example, a heat insulator for walls, floors and roofs of buildings or a tatami mat core.

2. Description of Prior Art

Because polystyrene resin foams have excellent heat insulating property and desirable mechanical strengths, boards thereof with a predetermined size are widely used as heat insulators. One known method for production of such a foam board comprises the steps of melting and kneading a polystyrene resin together with a cell controlling agent in an extruder, mixing the kneaded mass with a physical blowing agent, and extruding the resulting foamable mixture from the extruder into a lower pressure zone through a die attached to the extruder. A guider may be connected to the outlet of the die to increase the thickness of the foam board, if desired.

For the purpose of meeting the flammability standard on extruded polystyrene foam insulation boards as defined in JIS A9511-1995, a flame retardant is generally incorporated into the foam board. As the flame retardant, hexabromocyclododecane (hereinafter referred to as HBCD) is widely used. HBCD has a merit that the desired flame retardancy is obtainable in a relatively smaller amount as compared with other main flame retardants. As the blowing agent for use in the production of extruded polystyrene resin foam boards, chlorofluorohydrocarbons (hereinafter referred to as CFC) such as dichlorodifluoromethane have been hitherto widely used. Since CFC is likely to destroy the ozone layer, hydrogen-containing chlorofluorohydrocarbons (hereinafter referred to as HCFC) having a low ozone depleting potential are employed in place of CFC in recent years. However, HCFC, whose ozone depleting potential is not 0, is not without possibility of destroying the ozone layer. Thus, it has been proposed to use chlorine-free fluorohydrocarbons (which will be hereinafter referred to as HFC) or saturated hydrocarbons, which have an ozone depleting potential of 0 (zero), as the blowing agent. When a combustible blowing agent such as a saturated hydrocarbon is used as a blowing agent, it is necessary to use a larger amount of HBCD than that required when an incombustible blowing agent such as HFC is used, in order to impart sufficient flame retardancy to the extruded polystyrene resin foam board. When HBCD is used in a large amount, however, there are possibilities that the extrusion and foaming step cannot be carried out in a stable manner and that the physical properties of the resulting foam board are adversely affected, since HBCD has a decomposition temperature lower than other main known flame retardants. Thus, whilst HBCD has excellent flame retardancy, there is a strong demand for the development of extruded polystyrene resin foam boards in which the amount of HBCD is significantly reduced or in which a flame retardant other than HBCD is used. In addition, the study of the production of the foam board which uses a flame retardant except HBCD was merely demanded. In this circumstance, studies are being made on extruded polystyrene resin foam boards without using HBCD. For example, Japanese Unexamined Patent Publication No. JP-A-2003-292664 discloses a flame retardant in which a halogen-containing flame retardant such as brominated isocyanurate and/or brominated bisphenol is used together with a diphenylalkane. Using such a flame retardant, a foam board which meets the test specified in “Measuring Method A” in Section 4.13.1 of JIS A9511-1995 is described to be obtained.

Japanese Unexamined Patent Publication No. JP-A-2003-301064 proposes a flame retardant in which tetrabromobisphenol A diallyl ether, which is known to impart high flame retardancy to polystyrene, is used together with a halogen-containing flame retardant other than HBCD, such as dibromoneopentyl glycol, having a higher decomposition temperature than the diallyl ether.

The diphenylalkane proposed in JP-A-2003-292664, however, fails to exhibit sufficient heat resistance and, therefore, has still has a room to be improved in terms of the recyclability. The tetrabromobisphenol A diallyl ether described in JP-A-2003-301064 is low in heat resistance and, therefore, has problems with respect to recyclability and coloring.

Thus, HBCD must be used in a large amount in order to impart sufficient flame retardancy to extruded polystyrene resin foam boards when a combustible blowing agent is used as a blowing agent. This causes not only an increase of the production cost but also deterioration of the mechanical strengths and extrusion moldability of the foam boards. Extruded polystyrene foam boards obtained using a flame retardant other than HBCD, on the other hand, have problems with respect to recyclability and coloring. Additionally, such a flame retardant needs to be used in a relatively large amount and, therefore, poses problems similar to HBCD with respect to foaming moldability and mechanical strength.

### SUMMARY OF THE INVENTION

It is, therefore, an object of the present invention to provide a process capable of preparing an extruded polystyrene resin foam board having excellent flame retardancy and recyclability in a stable manner without causing deterioration of mechanical strengths thereof by extruding and foaming a foamable composition, the composition obtained by kneading a polystyrene resin, a blowing agent and a specific flame retardant in an extruder.

Another object of the present invention is to provide an extruded polystyrene resin foam board which contains a specific flame retardant and a specific blowing agent and which has excellent flame retardancy, environmental compatibility and recyclability.

The present invention relates to a process for preparing an extruded polystyrene resin foam board having excellent flame retardancy and recyclability in a stable manner by extruding and foaming a foamable composition, the composition obtained by kneading at least a polystyrene resin in an extruder, a blowing agent and a specific flame retardant, and to an extruded polystyrene resin foam board which contains a specific flame retardant and a specific blowing agent and which has excellent flame retardancy, environmental compatibility and recyclability.

Namely, the present invention provides a process for preparing an extruded polystyrene resin foam board having an apparent density of 20 to 60 kg/m³ and a thickness of 10 to 150 mm, comprising extruding a foamable composition, which contains at least a polystyrene resin, a flame retardant and a blowing agent and which has been molten and kneaded in an extruder, through a die attached to the extruder,

wherein the flame retardant comprises a phosphate ester and a brominated bisphenol ether compound represented by the following formula: 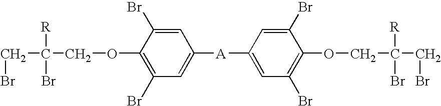
where R represents an alkyl group having 1 to 3 carbon atoms and A represents —C(CH₃)₂—, —SO₂—, —S—, —O—, —CO— or —CH₂—, and

wherein the phosphate ester and the brominated bisphenol ether compound are present in amounts of 0.1 to 6 parts by weight and 0.5 to 5 parts by weight, respectively, per 100 parts by weight of the polystyrene resin.

In the above process, the flame retardant preferably has a weight ratio of the brominated bisphenol ether compound to the phosphate ester of 0.3:1 to 30:1.

In any of the above processes, the brominated bisphenol ether compound is preferably at least one compound selected from the group consisting of 2,2-bis[4-(2,3-dibromo-2-methylpropoxy)-3,5-dibromophenyl]propane, bis[4-(2,3-dibromo-2-methylpropoxy)-3,5-dibromophenyl]sulfone, bis[4-(2,3-dibromo-2-methylpropoxy)-3,5-dibromophenyl]sulfide and bis[4-(2,3-dibromo-2-methylpropoxy)-3,5-dibromophenyl]methane.

In any of the above processes, the brominated bisphenol ether compound is preferably 2,2-bis[4-(2,3-dibromo-2-methylpropoxy)-3,5-dibromophenyl]propane.

In any of the above processes, the phosphate ester is preferably at least one compound selected from the group consisting of trimethyl phosphate, triethyl phosphate, tributyl phosphate, trioctyl phosphate, tris(2-ethylhexyl) phosphate, tris(butoxyethyl) phosphate, octyldiphenyl phosphate, triphenyl phosphate, tricresyl phosphate, trixylyl phosphate, cresyldiphenyl phosphate, 2-ethylhexyldiphenyl phosphate, cresyldi-2,6-xylyl phosphate, resolcinol bis(diphenyl phosphate) and bisphenol A bis(diphenyl phosphate).

In any of the above processes, the phosphate ester is preferably triphenyl phosphate.

In any of the above processes, the blowing agent preferably comprises (a) 10 to 80 mol % of a saturated hydrocarbon having 3 to 5 carbon atoms and (b) 90 to 20 mol % of at least one compound selected from the group consisting of methyl chloride, ethyl chloride, dimethyl ether, diethyl ether, methyl ethyl ether, methanol, ethanol, water and carbon dioxide, wherein a total of (a) and (b) is 100 mol %.

In any of the above processes, the blowing agent preferably comprises (a) 5 to 70 mol % of a saturated hydrocarbon having 3 to 5 carbon atoms, (b) 10 to 90mol % of at least one compound selected from the group consisting of methyl chloride, ethyl chloride, dimethyl ether, diethyl ether, methyl ethyl ether, methanol, ethanol, water and carbon dioxide and (c) 0 to 70 mol % of 1,1,1,2-tetrafluoroethane, wherein a total of (a), (b) and (c) is 100 mol %.

The present invention also provides an extruded polystyrene resin foam board having an apparent density of 20 to 60 kg/m³ and a thickness of 10 to 150 mm and containing 0.10 to 0.90 mol of a saturated hydrocarbon having 3 to 5 carbon atoms per 1 kg of the foam board and a flame retardant comprising a phosphate ester and a brominated bisphenol ether compound represented by the following formula: 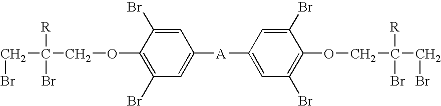
wherein R represents an alkyl group having 1 to 3 carbon atoms and A represents —C(CH₃)₂—, —SO₂—, —S—, —O—, —CO— or —CH₂—.

The present invention further provides an extruded polystyrene resin foam board having an apparent density of 20 to 60 kg/m³ and a thickness of 10 to 150 mm and containing 0 to 0.80 mol of 1,1,1,2-tetrafluoroethane per 1 kg of said foam board, 0.05 to 0.80 mol of a saturated hydrocarbon having 3 to 5 carbon atoms per 1 kg of said foam board and a flame retardant comprising a phosphate ester and a brominated bisphenol ether compound represented by the following formula: 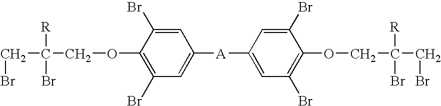
wherein R represents an alkyl group having 1 to 3 carbon atoms and A represents —C(CH₃)₂—, —SO₂—, —S—, —O—, —CO— or —CH₂—.

In any of the above foam boards, the brominated bisphenol ether compound is preferably 2,2-bis[4-(2,3-dibromo-2-methylpropoxy)-3,5-dibromophenyl]propane.

In any of the above foam boards, the phosphate ester is preferably triphenyl phosphate.

In the process for preparing an extruded polystyrene resin foam board according to the present invention, the foamable composition contains specific flame retardants in specific amounts. Therefore, the foamable composition, which contains at least a polystyrene resin, the flame retardant and a blowing agent, can be extruded with good moldability in a stable manner. The process is also advantageous with respect to the production cost and can give extruded polystyrene resin foam boards having excellent flame retardancy, heat insulating property, lightness in weight, dimensional stability, mechanical strengths and recyclability.

In one embodiment of the process for preparing an extruded polystyrene resin foam board according to the present invention, the above-described blowing agents are used in specific amounts. Therefore, by using specific blowing agent and specific flame retardant in combination, the process can give extruded polystyrene resin foam boards having excellent flame retardancy, heat insulating property, recyclability and environmental compatibility without using HFC or HCFC which has a possibility of destroying the ozone layer.

The extruded polystyrene resin foam board according to the present invention contains a saturated hydrocarbon having 3 to 5 carbon atoms in a specific amount and, therefore, has excellent heat insulating property. In particular, according to one embodiment of the present invention, there is provided an extruded polystyrene resin foam board which has an apparent density of 20 to 60 kg/m³, a thickness of 10 to 150 mm, an average cell diameter in the thickness direction of 0.05 to 0.3 mm, which contains a specific flame retardant other than HBCD and which does not contain HBCD or contains HBCD only a limited small amount. Whilst the combustible blowing agent is contained in the extruded polystyrene resin foam board, the use of a specific flame retardant other than HBCD can make it possible to impart excellent flame retardancy, production cost, recyclability and, particularly, heat insulating property to the foam board.

For imparting flame retardancy to synthetic resin articles, several methods are generally known. Such methods, however, cannot be simply applied to foamed articles having a cellular structure, since blowing agent gases are present in the cells and since the area of resin surfaces is high. Hitherto, HBCD has been used as a flame retardant for imparting flame retardancy to extruded polystyrene resin foam boards because of high flame retarding efficiency thereof. In this case, when an incombustibile blowing agent such as CFC is used for producing extruded polystyrene resin foam boards, it is not necessary to consider an influence of the gas contained in the cells upon flame retardancy. The only point to be taken into account is high resin surface area due to the cellular structure of the foam boards.

When CFC or HCFC is used as a blowing agent for the preparation of extruded polystyrene resin foam boards, the range of the extrusion and foaming temperature of a foamable polystyrene resin composition suitable for obtaining foam boards having a desired apparent density is relatively wide. Therefore, an influence of a variation of extrusion pressure, caused by decomposition of the flame retardant during the extrusion, upon moldability or stability of extrusion may be negligible. As long as HBCD is used as the flame retardant, it is not difficult to impart flame retardancy to extruded polystyrene resin foam boards.

In contrast, when HFC or a saturated hydrocarbon, which has no possibility of destroying the ozone layer, is used as the blowing agent, there is an increased possibility of deterioration of the stability of extrusion and foaming. Especially when a combustible saturated hydrocarbon is used as the blowing agent, it is necessary to use HBCD in a large amount in order to obtain satisfactory flame retardancy. When HBCD is used in a large amount, however, the stability of extrusion and foaming is considerably deteriorated.

In the present invention, the flame retardant used comprises a brominated bisphenol ether compound represented by the above structural formula and a phosphate ester. By using the specific flame retardant, the above problems caused by the use of HBCD can be solved.

With the process according to the present invention, extruded polystyrene resin foam boards having excellent flame retardancy may be obtained by using a specific combination of blowing agents even when one of the blowing agents has an ozone depleting potential of zero.

The extruded polystyrene resin foam board according to the present invention has an apparent density of 20 to 60 kg/m³ and a thickness of 10 to 150 mm and shows excellent flame retardancy, heat insulating property, lightness in weight, dimensional stability, physical properties, recyclability and environmental compatibility.

Other objects, features and advantages of the present invention will become apparent from the detailed description of the preferred embodiments to follow.

### DETAILED DESCRIPTION OF THE PREFERRED EMBODIMENTS

The feature of the process for preparing an extruded polystyrene resin foam board (hereinafter referred to as “extruded foam board”) according to the present invention resides in the use of the phosphate ester and the brominated bisphenol ether compound in amounts of 0.1 to 6 parts by weight and 0.5 to 5 parts by weight, respectively, per 100 parts by weight of the polystyrene resin. With regard to the other basic features of the process, suitably known methods for producing an extruded polystyrene resin foam board may be employed. For example, there may be used a method in which a foamable composition obtained by melting and kneading a polystyrene resin, a flame retardant and a blowing agent in an extruder is extruded from the extruder with high pressure condition into a low pressure zone (generally under the atmospheric pressure) through a flat die attached to the extruder so that the foamable composition is allowed to foam. The extruded mass is then passed through a shaping device disposed downstream of the die to obtain an extruded foam board. The shaping device may be a guider composed of a pair of upper and lower polytetrafluoroethylene plates which are disposed in parallel with each other or slightly inclined relative to each other such that the passage defined therebetween is enlarged from the inlet to the outlet thereof. Shaping rolls may be also used as the shaping device.

The foamable composition is a molten mass obtained by melting a polystyrene resin in an extruder and kneading the molten polystyrene resin together with a blowing agent, a flame retardant and, if necessary, one or more additives in the extruder. The foamable composition is cooled to adjust the melt viscosity thereof to a value suitable for foaming and then extruded from the extruder into a low pressure zone through a flat die. The foamable composition is generally cooled to 110 to 130° C., although the temperature varies according to the kind of the polystyrene resin, presence or absence of a fluidity improving agent, amount and kind of the fluidity improving agent, and amount and kind of the blowing agents.

As the polystyrene resin fed to the extruder in the process of the present invention, there may be mentioned, for example, styrene homopolymers and copolymers mainly composed of styrene such as a styrene-acrylic acid copolymer, a styrene-methyl acrylate copolymer, a styrene-ethyl acrylate copolymer, a styrene-methacrylic acid copolymer, a styrene-methyl methacrylic acid copolymer, a styrene-ethyl methacrylic acid copolymer, a styrene-maleic anhydride copolymer, a styrene-polyphenylene ether copolymer, a styrene-butadiene copolymer, a styrene-acrylonitrile copolymer, an acrylonitrile-butadiene-styrene terpolymer, a styrene-methylstyrene copolymer, a styrene-dimethylstyrene copolymer, a styrene-ethylstyrene copolymer and a styrene-diethylstyrene copolymer. These hompolymers and copolymers may be used alone or in combination of two or more thereof. The styrene copolymers preferably comprise styrene monomeric units of at least 50 mol %, more preferably at least 80 mol %.

The polystyrene resin may be a mixture with an other polymer or copolymer as long as the object, function and effect of the present invention are attained. Such an additional polymer or copolymer maybe, for example, a polyethylene resin such as ethylene homopolymers and ethylene copolymers having ethylene monomeric units of at least 50 mol %, a polypropylene resin such as propylene homopolymers and propylene copolymers having propylene monomeric units of at least 50 mol %, a polyphenylene ether resin, a styrene-butadiene-styrene block copolymer, a styrene-isoprene-styrene block copolymer, a hydrogenated styrene-butadiene-styrene block copolymer, a hydrogenated styrene-isoprene-styrene block copolymer or a styrene-ethylene copolymer. The additional polymers may be used alone or in combination of two or more thereof. The amount of such additional polymers is less than 50% by weight, preferably less than 30% by weight, particularly 0 to 10% by weight, based on the polystyrene resin.

The polystyrene resin for use in the present invention preferably has a melt flow rate (MFR) in the range of 0.5 to 30 g/10 min, more preferably 1 to 10 g/10 min (as measured according to JIS K7210-1976, Test Condition 8 of Method A) because excellent extrusion moldability and foamability can be obtained in producing the extruded foam board and because the resulting extruded foam board can have good appearance and high mechanical strengths.

The flame retardant used in the present invention comprises a brominated bisphenol ether compound represented by the structural formula shown below and a phosphate ester and can impart a high flame retardancy to the extruded foam board.

The brominated bisphenol ether compound represented by the structural formula shown below can effectively generate bromine radicals capable of exhibiting flame retardancy when the compound is heated at a decomposition temperature of the polystyrene resin. It is inferred that excellent flame retardancy of the brominated bisphenol ether compound is attributed to the presence of bromine atoms at the tertiary carbon atoms to which alky groups having 1-3 carbon atoms, such as a methyl group, represented by R in the below formula are bonded. The use of a brominated bisphenol ether compound of the formula shown below in which R represents a hydrogen atom (namely, the bromine atoms are bonded to the secondary carbon atoms) as a flame retardant is known.

The bond energy for the secondary carbon-bromine bond is greater than that for the tertiary carbon-bromine bond. It is, thus, inferred that the bromine atoms bonded to the tertiary carbon atoms of the brominated bisphenol ether compound used as the flame retardant in the present invention can form bromine radicals at a lower temperature as compared with the bromine atoms bonded to the secondary carbon atoms and that the thus generated bromine radicals cause chain reactions so that the other bromine atoms of the brominated bisphenol ether compound form radicals.

The thermal reduction temperature at which a weight loss of 5% occurs is 260° C. in the case of the brominated bisphenol ether compound represented by the structural formula shown below in which A represents —C(CH₃)₂— and R represents a methyl group and is 300° C. in the case of the similar brominated bisphenol ether compound represented by the structural formula shown below in which A represents —C(CH₃)₂— and R represents a hydrogen atom. This fact also supports the inferred mechanism of the flame retardant used in the present invention. The brominated bisphenol ether compound used in the present invention exhibits superior flame retardancy in comparison with the similar compound having bromine atoms bonded to the secondary carbons.

Although not to be bound by the theory, the brominated bisphenol ether compound exhibits the flame retardancy according to the following mechanism. Upon combustion of the foam board, the flame retardant is decomposed to generate bromine radicals. Since the bromine radicals react with active radicals produced by the decomposition of the polystyrene resin, the amount of the active radicals is reduced. Thus, the decomposition of the resin resulting in the formation of decomposition products which serve as a fuel can be suppressed. Additionally, incombustible gases such as hydrogen bromide, which are capable of shielding oxygen, are produced.

The brominated bisphenol ether compound used in the present invention is represented by the following formula: 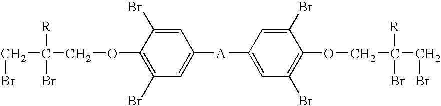
wherein R represents an alkyl group having 1 to 3 carbon atoms and A represents —C(CH₃)₂—, —SO₂—, —S—, —O—, —CO— or —CH₂—.

Examples of the brominated bisphenol ether compound is 2,2-bis[4-(2,3-dibromo-2-methylpropoxy)-3,5-dibromophenyl]propane, bis[4-(2,3-dibromo-2-methylpropoxy)-3,5-dibromophenyl]sulfone, bis[4-(2,3-dibromo-2-methylpropoxy)-3,5-dibromophenyl]sulfide and bis[4-(2,3-dibromo-2-methylpropoxy)-3,5-dibromophenyl]methane. Some of the above brominated bisphenol ether compounds may be commercially available. The brominated bisphenol ether compounds may be synthesized by etherizing the corresponding tetrabromobisphenol with methallyl chloride or 2-alkylallyl chloride, followed by addition of bromine to the double bond of the allyl group.

Above all, particularly preferred brominated bisphenol ether compound is 2,2-bis[4-(2,3-dibromo-2-methylpropoxy)-3,5-dibromophenyl]propane for reasons of its good compatibility with the polystyrene resin. Further, 2,2-bis[4-(2,3-dibromo-2-methylpropoxy)-3,5-dibromophenyl]propane, which has a decomposition initiation temperature of about 260° C. and a melting point of about 115° C., permits easy handling during the preparation of the extruded foam board and is hardly decomposed during the kneading step in an extruder, so that it is easy to obtain high flame retardancy. The above brominated bisphenol ether compounds may be used singly or in combination of two or more.

The brominated bisphenol ether compound is used in an amount of 0.5 to 5 parts by weight, preferably 0.5 to 4.5 parts by weight, more preferably 0.7 to 4 parts by weight, per 100 parts by weight of the polystyrene resin. An amount of the brominated bisphenol ether compound less than 0.5 parts by weight is insufficient to obtain satisfactory flame retardancy. Too large an amount of the brominated bisphenol ether compound causes a reduction of the physical properties, such as mechanical strength, of the foam board.

The phosphate ester used in conjunction with the brominated bisphenol ether compound as the flame retardant can exhibit excellent flame retardancy because it can form a stable heat shielding layer through the formation of char by dehydration.

Illustrative of suitable phosphate esters are trimethyl phosphate, triethyl phosphate, tributyl phosphate, trioctyl phosphate, tris(2-ethylhexyl) phosphate, tris(butoxyethyl) phosphate, tris (bromophenyl) phosphate, tris (tribromoneopentyl) phosphate, octyldiphenyl phosphate, triphenyl phosphate, tricresyl phosphate, trixylyl phosphate, cresyldiphenyl phosphate, 2-ethylhexyldiphenyl phosphate, cresyldi-2,6-xylyl phosphate, resolcinol bis(diphenyl phosphate) and bisphenol A bis(diphenyl phosphate). Above all, aromatic phosphate esters are preferred. Triphenyl phosphate is particularly preferred. The above phosphate esters may be used singly or in combination of two or more.

The phosphate ester is used in an amount of 0.1 to 6 parts by weight, preferably 0.5 to 4 parts by weight, per 100 parts by weight of the polystyrene resin. Too large an amount of the phosphate ester causes a reduction of the mechanical strength of the foam board. Further, when the phosphate ester, which has a plasticizing property, is used in excess, the foamable composition has so high a fluidity that the extrusion and foaming procedures may not be carried out in a stable manner. When the amount of the phosphate ester is below 0.1 parts, it is not possible to obtain satisfactory flame retardancy.

The combination of the above-described specific brominated bisphenol ether compound and the phosphate ester gives synergetic flame retardancy through mutually complementary effects on flame retardancy. In particular, they exhibit synergetic effect on oxygen index which gives an indication of the flame retardancy.

It is preferred that the brominated bisphenol ether compound and the phosphate ester be used in such a proportion that the weight ratio of the brominated bisphenol ether compound to the phosphate ester is 0.3 to 30, more preferably 0.5 to 20, particularly preferably 0.8 to 10, for reasons of providing desired mutually complementary effects on flame retardancy.

The above flame retardant composed of brominated bisphenol ether compound and the phosphate ester may be mixed with the polystyrene resin by feeding a predetermined amount of the flame retardant together with the polystyrene resin from a raw material feed port provided at an upstream end of an extruder. The feeds of the flame retardant and the polystyrene resin are then kneaded together in the extruder. Alternatively, the flame retardant may be fed from a port provided in a midway of the extruder and mixed with the molten polystyrene resin fed from an upstream end of the extruder.

The flame retardant may be fed to the extruder by various suitable methods, such as a method in which a dry blend of the flame retardant and the polystyrene resin is fed to the extruder, a method in which a molten mixture of the flame retardant and the polystyrene resin obtained in a kneader is fed to the extruder, a method in which a liquid obtained by melting the flame retardant is fed to the extruder, and a method in which a previously prepared master batch containing the flame retardant is fed to the extruder. For reasons of good dispersibility, the use of the master batch method is preferred.

The flame retardant master batch may be preferably prepared using a polystyrene resin having MFR of 0.5 to 30 g/10 min as a base resin such that the content of the flame retardant in the master batch is 5 to 95% by weight, preferably 40 to 95% by weight, based on a total weight of the base resin and the flame retardant. The brominated bisphenol ether compound and the phosphate ester may be fed to the extruder separately or as a mixture. For example, a master batch containing the base resin, the brominated bisphenol ether compound and the phosphate ester may be prepared and fed to the extruder. Alternatively, a master batch containing the base resin and the brominated bisphenol ether compound and another master batch containing the base resin and the phosphate ester may be separately fed to the extruder.

It is preferred that a stabilizing agent be incorporated into the foamable composition. Examples of the stabilizing agent include metal soap, an organic tin compound, a lead compound, hydrotalcite, an epoxy compound, a polyhydric alcohol, a β-ketone, a phenolic compound, a hindered amine compound, a phosphorus compound and a sulfur compound. These stabilizing agents serve to capture halogen radicals and halogen ions generated by the decomposition of the bromine-containing flame retardant and to suppress the coloring and the reduction in the molcular weight of the polymer. The stabilizing agent is generally used in an amount of 0.2 to 20 parts by weight, preferably 1 to 15 parts by weight, per 100 parts by weight of a total weight of the flame retardant.

If necessary, one or more flame retardants other than the brominated bisphenol ether compound and the phosphate ester may be additionally used, as long as the effect of the present invention is not adversely affected. Such an additional flame retardant includes diphenylalkanes such as 2,3-dimethyl-2,3-diphenylbutane; inorganic compounds such as antimony trioxide, diantimony pentaoxide, ammonium sulfate, zinc stanate, silicone compounds, boron oxide, zinc borate and zinc sulfide; nitrogen-containing cyclic compounds such as cyanuric acid, isocyanuric acid, triarylisocyanurate, melamine cyanurate, melamine, melam and melem; phosphorus compounds such as red phosphorus, ammonium polyphosphoric acid and phosphazen; halogenated aliphatic compounds such as tetrabromocyclooctane; halogenated aromatic compounds and derivatives thereof such as hexabromobenzone, pentabromotoluene, ethylenebispentabromodiphenyl, decabromodiphenyl oxide, 2,3-dibromopropylpentabromophenyl oxide, polybromophenylindane, polypentabromobenzyl acrylate, brominated polyphenylene oxide and brominated polystyrene; halogenated bisphenol A compounds and derivatives thereof such as tetrabromobisphenol A, tetrabromobisphenol A bis(2,3-dibromopropyl) ether, tetrabromobisphenol A bis(2-bromoethyl) ether and tetrabromobisphenol A diallyl ether; halogenated bisphenol S compounds and derivatives thereof such as tetrabromobisphenol S, tetrabromobisphenol S bis(2,3-dibromopropyl) ether and tetrabromobisphenol S bis(2-bromoethyl) ether; oligomers of halogenated bisphenol compounds derivatives such as tetrabromobisphenol A polycarbonate oligomers and tetrabromobisphenol epoxy oligomers; and halogen- and nitrogen-containing compounds such as ethylenebis(tetrabromophthal)imide, tris(tribromophenoxy)triazine and tris(2,3-dibromopropyl)isocyanurate.

The extruded polystyrene resin foam board obtained by the process of the present invention has excellent flame retardancy because the specific flame retardant is contained therein. When the use of the specific flame retardant is combined with a specific cell structure and/or a specific blowing agent composition remaining in the foam board as described hereinafter, the foam board has excellent heat insulating property as well as improved flame retardancy.

As a blowing agent, any customarily employed physical blowing agent may be used for the purpose of the present invention. If necessary, the physical blowing agent may be used in conjunction with a suitable chemical blowing agent such as azodicarbonamide. Such a chemical blowing agent may also serve as a cell controlling agent for reducing the cell diameter of the foam board.

Examples of the physical blowing agent include saturated hydrocarbons having 3 to 5 carbon atoms such as propane, n-butane, isobutane, n-pentane, isopentane and cyclopentane; HFC such as 1,1,1,2-tetrafluoroethane, 1,1-difluoroethane, 1,1,1,3,3-pentafluoropropane and 1,1,1,3,3-pentafluorobutane; ethers such as dimethyl ether, diethyl ether and methyl ethyl ether; lower alcohols such as methanol, ethanol, isopropanol and propanol; alkyl chlorides having 1 or 2 carbon atoms such as methyl chloride and ethyl chloride; and inorganic gases such as carbon dioxide, nitrogen and water.

Among the above physical blowing agents, a saturated hydrocarbon having 3 to 5 carbon atoms is preferably used in order to obtain extruded foam board having a low apparent density, since the hydrocarbon is fairly soluble in the polystyrene resin without considerably plasticizing the polystyrene resin. Further, isobutane, isopentane and cyclopentane are preferably used in order to obtain foam boards having a high heat insulating property, since they are fairly soluble in the polystyrene resin and can remain present in the foam board to contribute to the maintenance of the heat insulating property. However, the saturated hydrocarbons having 3 to 5 carbon atoms which are combustible gases are not preferable from the standpoint of the flame retardancy of the foam board, though they are suited for obtaining foam boards having a low apparent density and a high heat insulating property.

In this circumstance, in the present invention, a blowing agent composition which comprises at least one easily permeable blowing agent selected from methyl chloride, ethyl chloride, dimethyl ether, diethyl ether, methyl ethyl ether, methanol, ethanol, carbon dioxide and water; a saturated hydrocarbon having 3 to 5 carbon atoms; and optionally HFC is preferably used. The combination of the easily permeable blowing agent and the hydrocarbon has a merit that the easily permeable blowing agent can escape immediately or early after the extrusion so that the foaming proceeds in a facilitated manner and the apparent density of the foam board is reduced. There is obtained an additional merit that the amount of the saturated hydrocarbon can be reduced and, therefore, the flame retardancy is improved. Thus, the heat insulating property and flame retardancy of the foam board can be stabilized early after production. Especially when the easily permeable blowing agent and the hydrocarbon, such as isobutane, which can remain present in the foam board for a long period of time, are used as the blowing agent, it is possible to obtain a foam board which shows excellent flame retardancy and high heat insulating property for a long time.

It is particularly preferred that the blowing agent comprise a combination of (a) 10 to 80 mol % of a saturated hydrocarbon having 3 to 5 carbon atoms and (b) 90 to 20 mol % of at least one compound selected from the group consisting of methyl chloride, ethyl chloride, dimethyl ether, diethyl ether, methyl ethyl ether, methanol, ethanol, water and carbon dioxide, wherein a total of (a) and (b) is 100 mol % or a combination of (a) 5 to 70 mol % of a saturated hydrocarbon having 3 to 5 carbon atoms, (b) 10 to 90 mol % of at least one compound selected from the group consisting of methyl chloride, ethyl chloride, dimethyl ether, diethyl ether, methyl ethyl ether, methanol, ethanol, water and carbon dioxide and (c) 0 to 70 mol % of 1,1,1,2-tetrafluoroethane, wherein a total of (a), (b) and (c) is 100 mol %.

The amount of the blowing agent used depends upon various conditions such as the kind thereof, the apparent density of the desired foam board and the kind of the polystyrene resin and is difficult to specify. Generally, however, the amount of a physical blowing agent (a total amount when two or more blowing agents are used in combination) is 0.7 to 2.5 mols, preferably 0.85 to 2.0 mols, per 1 kg of the polystyrene resin. When the physical blowing agent is used together with a chemical blowing agent, the amount of the physical blowing agent is similar to the above. The chemical blowing agent is used in an amount of 0.1 to 10 parts by weight per 100 parts by weight of the polystyrene resin.

The foamable composition used in the process of the present invention may contain a cell controlling agent for adjusting the average cell diameter of the foam board. An inorganic substance such as talc, kaolin, mica, silica, calcium carbonate, barium sulfate, titanium oxide, clay, aluminum oxide, bentonite, diatomaceous earth or a mixture of two or more thereof may be suitably used as the cell controlling agent. Above all, talc is suitably used for reasons of easiness in adjusting the cell size and in obtaining a small cell size. Particularly preferably used is talc having an average diameter of 0.5 to 10 μm (in terms of 50% particle size as measured by the light transmission centrifugal sedimentation method). The cell controlling agent is preferably used in an amount of 0.01 to 7.5 parts by weight, more preferably 0.1 to 5 parts by weight, per 100 parts by weight of the polystyrene resin.

In addition to the cell controlling agent, the foamable composition may contain various additives such as a heat insulation improver (e.g. titanium oxide, graphite, hydrotalcite, carbon black and aluminum), a coloring agent, an anti-oxidizing agent, a filler and a lubricant, as long as the objects and effects of the present invention are not adversely affected. The additives such as cell controlling agent and coloring agent may be added to the foamable composition in the same manner as the flame retardant is added.

The description will be next made of the extruded polystyrene resin foam board of the present invention.

The extruded polystyrene resin foam board of the present invention contains the brominated bisphenol ether compound represented by the above formula and the phosphate ester as the flame retardant. By this expedience, the desired objects of the present invention may be fulfilled as described above. Whether or not the brominated bisphenol ether compound is present in a foam board may be determined by known qualitative analysis such as infrared absorption spectroscopy. Whether or not the phosphate ester is present in a foam board may be determined by known qualitative analysis such as High Performance Liquid Chromatography.

The apparent density of the extruded polystyrene resin foam board is 20 to 60 kg/m³, preferably 22 to 50 kg/m³. It is very difficult to prepare a foam board having an apparent density of less than 20 kg/m³. Even when such a small density foam board is prepared, the mechanical strength thereof is not satisfactory as compared with the known foam insulation boards and, therefore, such a foam board is usable only for limited applications. When the apparent density is greater than 60 kg/m³, it is difficult to impart sufficient heat insulating property to the foam board unless the thickness thereof is sufficiently large. An excessively large apparent density of the foam board is also disadvantageous with respect to the lightness in weight.

The thickness of the extruded polystyrene resin foam board is 10 to 150 mm, preferably 20 to 100 mm. Too large a thickness in excess of 150 mm is disadvantageous because the uniform mechanical strength and dimensional stability cannot be ensured and because a large extruder is required for producing the foam board in a stable manner. A difficulty is involved in the preparation of a foam board having a thickness is less than 10 mm. Even when such a thick foam board is prepared, its absolute mechanical strength and heat insulation property are insufficient for practical use.

The extruded polystyrene resin foam board according to one aspect of the present invention contains a saturated hydrocarbon having 3 to 5 carbon atoms in an amount of 0.10 to 0.90 mol, preferably 0.15 to 0.75 mol, more preferably 0.20 to 0.65 mol, per 1 kg of the foam board. As used in this specification and the appended claims, the reference to “the hydrocarbon having 3 to 5 carbon atoms” includes two or more such hydrocarbons. Therefore, when two or more hydrocarbons having 3 to 5 carbon atoms are contained in the foam board, the above necessary, preferred and more preferred ranges are for the total molar amount of them. The foam board containing 0.10 to 0.90 mol of the hydrocarbon having 3 to 5 carbon atoms shows a thermal conductivity of not greater than 0.040 W/m·K and has high heat insulating property. As used herein, the thermal conductivity is as measured according to the method described in JIS A9511-1995, Section 4.7, “Flat plate , heat flow meter method” (two heat flow meter system, high temperature-side hot plate temperature: 35° C., low temperature-side hot plate temperature: 5° C., average temperature: 20° C.). The lower limit of the thermal conductivity is not specifically limited but is generally 0.02 W/m·K. When the content of the saturated hydrocarbon is below 0.10 mol per 1 kg of the foam board, it is difficult to obtain a sufficiently high heat insulating property, unless a low thermal conductivity blowing agent such as HFC is used together. When the saturated hydrocarbon content exceeds 0.90 mol per 1 kg of the foam board, it is impossible to obtain sufficiently high flame retardancy for use as construction materials. From the standpoint of environmental compatibility, the foam board is desired not to contain CFC and HCFC which are likely to destroy the ozone layer.

The extruded polystyrene resin foam board according to another aspect of the present invention contains 0 to 0.80 mol, preferably 0.10 to 0.70 mol, more preferably 0.15 to 0.60 mol, of 1,1,1,2-tetrafluoroethane per 1 kg of the foam board, and 0.05 to 0.80 mol, preferably 0.10 to 0.70 mol, more preferably 0.15 to 0.65 mol, of a saturated hydrocarbon having 3 to 5 carbon atoms per 1 kg of the foam board. Such a foam board shows has high heat insulating property. In particular, such a foam board, when its average cell diameter in the thickness direction is within the below specified range, shows a thermal conductivity of not greater than 0.034 W/m·K, particularly not greater than 0.030 W/m·K, more particularly 0.028 W/m·K, as measured according to the aforementioned method described in JIS A9511-1995, Section 4.7, “Flat plate, heatflow meter method”. The lower limit of the thermal conductivity is not specifically limited but is generally 0.02 W/m·K.

Too high a content of 1,1,1,2-tetrafluoroethane is disadvantageous because foaming is apt to occur within the die so that the surface condition and mechanical strength of the resulting foam board become unsatisfactory.

When the content of the saturated hydrocarbon is below 0.05 mol per 1 kg of the foam board, it is difficult to obtain a sufficiently high heat insulating property, unless a low thermal conductivity blowing agent such as HFC is used together. When the saturated hydrocarbon content exceeds 0.80 mol per 1 kg of the foam board, it is impossible to obtain sufficiently high flame retardancy for use as construction materials, unless a flame retardant is used in a large amount.

1,1,1,2-Tetrafluoroethane has a low thermal conductivity, remains present in a polystyrene resin foam board for a long time and is incombustible. Therefore, a foam board having high flame retardancy and high heat insulting property can be easily obtained using 1,1,1,2-tetrafluoroethane. Additionally, 1,1,1,2-tetrafluoroethane has an ozone depleting potential of zero and may be suited for practical use. However, the global warming potential of 1,1,1,2-tetrafluoroethane is higher than that of a saturated hydrocarbon having 3 to 5 carbon atoms. It is, therefore, desirable to use 1,1,1,2-tetrafluoroethane together with a saturated hydrocarbon having 3 to 5 carbon atoms. In this case, foam boards having excellent flame retardancy, heat insulating property and environmental compatibility may be obtained by adjusting the amounts of 1,1,1,2-tetrafluoroethane and a saturated hydrocarbon having 3 to 5 carbon atoms as described above.

When 1,1,1,2-tetrafluoroethane is used in a reduced amount or is not used, it is preferable to use at least one of isobutane, isopentane and cyclopentane which can remain present for a long time in the foam board as the saturated hydrocarbon having 3 to 5 carbon atoms. In this case, foam boards having excellent flame retardancy, heat insulating property and environmental compatibility may be obtained by adjusting the amount such a saturated hydrocarbon having 3 to 5 carbon atoms as described above.

The content of the blowing agent in the foam board is measured by gas chromatography. For example, a specimen is cut out from a central region of the foam board and is charged in a capped vial containing toluene. After closing the vial, the blowing agent contained in the specimen is dissolved in the toluene with sufficient agitation. The thus obtained sample solution is subjected to gas chromatography and is quantitatively analyzed by the internal standard method to determine the contents of 1,1,1,2-tetrafluoroethane, a saturated hydrocarbon having 3 to 5 carbon atoms and so on.

The content of the blowing agent in the foam board can be controlled by suitably controlling the amount of the blowing agent fed to an extruder during the preparation of the foam board with consideration of the solubility and gas permeation rate of the blowing agent in the polystyrene resin used. For example, since isobutane and 1,1,1,2-tetrafluoroethane are very soluble in a polystyrene resin and have low gas permeation rates, the amounts of them used in the production of a foam board are substantially the same as the amounts contained in the foam board produced.

When an easily permeable blowing agent, such as water, carbon dioxide or dimethyl ether, having a high gas permeation rate through a polystyrene resin is used, it is possible to control the apparent density of the foam board without any substantial influence upon the adjustment of the content of the blowing agent in the foam board. Thus, a foam board having both a specifically adjusted blowing agent content and a specifically adjusted apparent density may be obtained by using a blowing agent having a high gas permeation rate and an additional blowing agent having a low gas permeation rate in combination.

It is preferred that the foam board of the present invention have an average cell diameter in the thickness direction of 0.05 to 1.5 mm, more preferably 0.05 to 0.30 mm, still more preferably 0.06 to 0.25 mm, most preferably 0.07 to 0.20 mm, for reasons of obtaining a high heat insulating property. In order to obtain a particularly high heat insulating foam board having a thermal conductivity of not greater than 0.034 W/m·K as measured according to the aforementioned method described in JIS A9511-1995, Section 4.7, “Flat plate, heat flow meter method”, in particular, such a foam board, it is desirable that not only the average cell diameter in the thickness direction is within the above range but also the contents of isobutane and 1,1,1,2-tetrafluoroethane in the foam board are within the range described previously. When the above conditions are met, it is possible to reduce the amount of HFC and the combustible blowing agent and to improve the environmental compatibility and flame retardancy of the foam board.

The foam board of the present invention preferably has an average cell diameter in the transverse direction of 0.05 to 1.5 mm, more preferably 0.05 to 0.30 mm, most preferably 0.07 to 0.20 mm and an average cell diameter in the extrusion direction (longitudinal direction) of 0.05 to 1.5 mm, more preferably 0.05 to 0.30 mm, most preferably 0.07 to 0.20 mm.

A method of measuring the average cell diameter of an extruded foam board herein will be described below. The foam board is cut vertically (in the thickness direction) along the transverse direction (in the direction perpendicular to the extrusion direction), and the resulting transverse cross-section is measured for the average cell diameter in the thickness direction DT (mm) and the average cell diameter in the transverse direction DW (mm). The foam board is also cut vertically in the extrusion direction (longitudinal direction) along the center line so as to divide the foam board into approximately equal halves, and the resulting longitudinal cross-section is measured for the average cell diameter in the extrusion direction DL (mm). Thus, using a microscope, an enlarged image of each of the transverse and longitudinal cross-sections is projected on a screen or monitor. On the projected image, a straight line is drawn in the direction to be measured and the number of cells through which the line passes is counted. The average cell diameter is obtained by dividing the length of the line (which is not the length on the enlarged projected image but the real length calculated taking the magnification into account) by the counts of the cells measured.

More specifically, the average cell diameter in the thickness direction DT (mm) is obtained as follows. In the transverse cross-section of the foam board, three lines extending in the thickness direction throughout the entire thickness thereof are drawn at a center part and at two opposite near an end parts thereof. An average diameter of the cells on each of the three lines is obtained from the length of the line and the number of the cells through which the line passes (the length of the line/the number of the cell through which the line passes), and the arithmetic mean of the thus obtained three average diameters represents the average cell diameter in the thickness direction DT (mm) of the foam board.

The average cell diameter in the transverse direction DW (mm) of the extruded foam board is obtained as follows. In the transverse cross-section of the extruded foam board, three lines each having a length of 30 mm and each extending in the transverse direction along the center line so as to divide the cross-section into approximately equal halves are drawn at a center part and two opposite near an end parts thereof. From the length of the line (30 mm) and the number (N) of the cells through which the line passes, an average diameter of the cells on the line is given as 30/(N-1). The arithmetic mean of the thus obtained three average diameters represents the average cell diameter in the transverse direction DW (mm) of the foam board.

The average cell diameter in the longitudinal direction DL (mm) of the extruded foam board is obtained as follows. In the longitudinal cross-section of the extruded foam board, three lines each having a length of 30 mm and each extending in the longitudinal direction along the center line so as to divide the cross-section into approximately equal halves are drawn at a center part and two opposite near an end parts thereof. From the length of the line (30 mm) and the number (N) of the cells through which the line passes, an average diameter of the cells on the line is given as 30/(N-1). The arithmetic mean of the thus obtained three average diameters represents the average cell diameter in the longitudinal direction DL (mm) of the foam board. The average cell diameter in the horizontal direction DH (mm) is the arithmetic mean of DW and DL.

The extruded foam board of the present invention preferably has a cell strain rate of 0.7 to 2.5, more preferably 0.8 to 2.0, most preferably 0.8 to 1.5 for reasons of obtaining high heat insulating property, excellent dimensional stability and high compressive strength. As used herein, the cell strain rate is given as DT/DH wherein DT and DH are as defined immediately above. The lesser the cell strain rate is than 1, the flatter the shape of the cell. The greater the cell strain rate is than 1, the more vertically elongated the shape of the cell.

As a method for obtaining the extruded foam board having a small average cell diameter in the thickness direction DH, there may be mentioned a method in which the above-described cell controlling agent is incorporated into the foamable composition in an increased amount so as to reduce the cell size. With this method, however, the open cell content of the foam board increases so that it is not easy to obtain the desired high heat insulating property. One suitable method of obtaining small average cell diameter DH includes the use of a cell controlling agent in an increased amount while suitably selecting a polystyrene resin showing a high melt viscosity without excessively reducing MFR. Alternatively, the use of an inorganic blowing agent such as carbon dioxide as part of the above-described physical blowing without an excessive addition of a cell controlling agent can give the extruded foam board having a small average cell diameter DH. Further, the desired cell strain rate may be obtained by the method disclosed in U. S. Patent Application Publication No. 20030042644 the disclosure of which is hereby incorporated by reference herein.

It is particularly preferred that the extruded foam board of the present invention meets the combustibility standard for extruded polystyrene foam heat insulating boards described in JIS A9511-1995. Namely, it is desired that, when the foam board is measured for the flammability according to Measuring Method A described in Section 4.13.1 of JIS A9511-1995, the flame extinguishing time be no more than 3 seconds, no residues remain present and no combustion occur beyond the line indicating the combustion limit. Such a foam board has sufficient safety required for use as an extruded polystyrene foam heat insulating board for construction materials.

The extruded foam board of the present invention preferably has a closed cell content of at least 90%, more preferably at least 93%, for reasons of improved heat insulating property and improved mechanical strength. The higher the closed cell content, the higher is the heat insulating efficiency and the longer is the period of time for maintaining the high heat insulating efficiency.

The closed cell content of the extruded foam board is obtained according to Procedure C of ASTM D-2856-70 as follows. The true volume Vx of a cut sample of the extruded foam board is measured using Air Comparison Pycnometer Type-930 manufactured by Toshiba Beckmann Inc. At this time, a cut sample cut into the size of 25 mm×25 mm×20 mm and having no molded skin is placed in a sample cup for measurement. When the extruded foam board is so thin that a cut sample having a thickness of 20 mm cannot be cut off therefrom, the measurement may be conducted using, for example, two cut samples having a size of 25 mm×25 mm×10 mm together. The closed cell content S (%) is calculated by the following formula:
S(%)=(Vx−W/ρ)×100/(VA−W/ρ)
wherein

Vx: True volume (cm³) of the cut sample(s) measured by the above method, which corresponds to a sum of a volume of the resin constituting the cut sample(s) and a total volume of all the closed cells in the cut sample(s);

VA: Apparent volume (cm³) of the cut sample(s) used for the measurement, which is calculated from the outer dimension thereof;

W: Weight (g) of the cut sample(s) used for the measurement; and

ρ: Density (g/cm³) of the resin constituting the extruded foam board.

The following examples will further illustrate the present invention. The present invention is not limited to the examples, however. Parts are by weight except otherwise noted.

### EXAMPLES 1 AND 2 AND COMPARATIVE EXAMPLES 1 AND 2

Raw Materials:

Polystyrene (HH32 made by PS Japan Inc.), a talc master batch (a master batch composed of 35% by weight of the same polystyrene as above, 60% by weight of talc (High Filler #12, made by Matsumura Sangyo Co., Ltd.) and 5% by weight of an additive) as a cell controlling agent, and a flame retardant were used as raw materials. The flame retardant was composed of 2,2-bis[4-(2,3-dibromo-2-methylpropoxy)-3,5-dibromophenyl]propane (TBBA) as a brominated bisphenol ether compound and triphenyl phosphate (TPP) as a phosphate ester. The amounts of the talc master batch and respective flame retardant components (TBBA and TPP) per 100 parts of the polystyrene were as shown in Table 1. The weight ratio of TBBA to TPP is also shown in Table 1. A stabilizing agent was mixed with the above raw materials in an amount of 10 parts per 100 parts of the flame retardant (total of TBBA and TPP). The stabilizing agent was a mixture of a phenol compound (IRGANOX 1010 manufactured by Chiba Specialty Chemicals Inc.) and a phosphorus compound (ADECASTAB PEP-36 manufactured by Asahi Denka Co., Ltd.) with a weight ratio of the phenol compound to the phosphorus compound of 5:1.

A blowing agent was a mixture of isobutane and methyl chloride. The amounts of respective blowing agent components (isobutane and methyl chloride) per 1 kg of the polystyrene were as shown in Table 1. The proportions (mol %) of the isobutane and methyl chloride in the blowing agent are also shown in Table 1.

Extruding System:

The extruding system had a first extruder having a diameter of 65 mm, a second extruder having a diameter of 90 mm and a third extruder having a diameter of 150 mm connected in series. A die having a die lip with a width of 115 mm and a lip gap of 1.0 mm (rectangular parallelepiped cross-section) was attached to the tip end of the third extruder.

Extrusion Conditions and Procedures:

The above raw materials were fed to the first extruder and melted and kneaded at 220° C. The blowing agent was injected into the kneaded mixture at a position near the downstream end of the first extruder to obtain a molten mixture. The mixture was subsequently passed successively through the second and third extruders so that the temperature of the mixture was controlled to a foaming temperature of 110 to 130° C. to obtain a foamable composition. The foamable composition was then extruded through the die lip into the atmosphere.

The extruded mass while foaming was passed through a guider composed of a pair of upper and lower polytetrafluoroethylene resin plates to obtain an extruded foam board.

The apparent density, thickness, closed cell content, average cell diameter in the thickness direction, cell strain rate, thermal conductivity, flammability, extrusion moldability and residual amount of blowing agents of each of the thus obtained extruded foam boards are also shown in Table 1.

### EXAMPLES 3 AND 4

An extruded foam board was prepared in the same manner as described in Example 1 except that the amounts of the talc master batch, respective flame retardant components and respective blowing agent components were changed as shown in Table 1 and that the die gap was changed to 1.5 mm. The apparent density, thickness, closed cell content, average cell diameter in the thickness direction, cell strain rate, thermal conductivity, flammability, extrusion moldability and residual amount of blowing agents of each of the thus obtained extruded foam boards are summarized in Table 1.

### EXAMPLE 5

An extruded foam board was prepared in the same manner as described in Example 3 except that the amounts of respective flame retardant components were changed as shown in Table 1. The apparent density, thickness, closed cell content, average cell diameter in the thickness direction, cell strain rate, thermal conductivity, flammability, extrusion moldability and residual amount of blowing agents of the thus obtained extruded foam board are summarized in Table 1.

TABLE 1

| | | | | | | | | Comparative | |
|---|---|---|---|---|---|---|---|---|---|
| | | | Example | | | | | Example | |
| | | | 1 | 2 | 3 | 4 | 5 | 1 | 2 |
| Amounts of | Polystyrene (part) | | 100 | 100 | 100 | 100 | 100 | 100 | 100 |
| polystyrene, | Talc master batch (part) | | 0.84 | 0.84 | 4.2 | 4.2 | 4.2 | 0.84 | 0.84 |
| talc master | Flame | TBBA *2 (part) | 1.4 | 1.0 | 2.7 | 2.0 | 2.3 | 0.07 | 13.5 |
| batch, flame | retardant | TPP *3 (part) | 0.45 | 0.34 | 0.9 | 0.68 | 1.3 | 0.02 | 4.5 |
| retardant and | Weight ratio TBBA/TPP | | 3.1 | 2.9 | 3.0 | 2.9 | 1.8 | 3.5 | 3.0 |
| blowing agent | Blowing agent | Isobutane (mol/kg) | 0.24 | 0.24 | 0.58 | 0.58 | 0.58 | 0.24 | 0.24 |
| | | Methyl chloride | 0.96 | 0.96 | 0.47 | 0.47 | 0.47 | 0.96 | 0.96 |
| | | (mol/kg) | | | | | | | |
| | Proportion of | Isobutane (mol %) | 20 | 20 | 55 | 55 | 55 | 20 | 20 |
| | blowing agent | Methyl chloride | 80 | 80 | 45 | 45 | 45 | 80 | 80 |
| | components | (mol %) | | | | | | | |
| Properties | Apparent density (kg/m³) | | 34.7 | 36.0 | 36.5 | 37.0 | 35.7 | 36.5 | — |
| of extruded | Thickness (mm) | | 27 | 27 | 27 | 27 | 27 | 27 | — |
| foam boards | Closed cell content (%) | | 93 | 94 | 95 | 95 | 94 | 94 | — |
| | Average cell diameter in the | | 0.45 | 0.48 | 0.16 | 0.15 | 0.17 | 0.44 | — |
| | thickness direction (mm) | | | | | | | | |
| | Cell strain rate | | 1.3 | 1.3 | 1.0 | 1.1 | 1.0 | 1.3 | — |
| | Thermal conductivity after 4 weeks | | 0.034 | 0.034 | 0.027 | 0.027 | 0.027 | 0.036 | — |
| | (W/m · K) | | | | | | | | |
| | Flammability after 4 weeks | | A | B | A | B | A | C | — |
| | Extrusion moldability | | A | A | A | A | A | A | *1 |
| | Residual | Isobutane (mol/kg) | 0.21 | 0.21 | 0.54 | 0.53 | 0.54 | 0.20 | — |
| | amounts of | Methyl chloride | 0 | 0 | 0 | 0 | 0 | 0 | — |
| | blowing agent | (mol/kg) | | | | | | | |
| | after 4 weeks | | | | | | | | |

*1: Foam board was not obtained because the die pressure was unable to be maintained
*2: TBBA: 2,2-Bis(4-(2,3-dibromo-2-methylpropoxy)-3,5-dibromophenyl)propane
*3: TPP: Triphenyl phosphate

### EXAMPLE 6

An extruded foam board was prepared in the same manner as described in Example 1 except that the amounts of the talc master batch and respective flame retardant components were changed as shown in Table 2 and that the blowing agent was changed to a mixture of isobutane, ethanol and carbon dioxide. The amounts of respective blowing agent components (isobutane, ethanol and carbon dioxide) per 1 kg of the polystyrene were as shown in Table 2. The apparent density, thickness, closed cell content, average cell diameter in the thickness direction, cell strain rate, thermal conductivity, flammability, extrusion moldability and residual amount of blowing agents of each of the thus obtained extruded foam boards are summarized in Table 2.

### EXAMPLE 7

An extruded foam board was prepared in the same manner as described in Example 6 except that the blowing agent was changed to a mixture of isobutane, dimethyl ether and carbon dioxide. The amounts of respective blowing agent components (isobutane, dimethyl ether and carbon dioxide) per 1 kg of the polystyrene were as shown in Table 2. The apparent density, thickness, closed cell content, average cell diameter in the thickness direction, cell strain rate, thermal conductivity, flammability, extrusion moldability and residual amount of blowing agents of each of the thus obtained extruded foam boards are summarized in Table 2.

TABLE 2

| | | | Example | |
|---|---|---|---|---|
| | | | 6 | 7 |
| Amounts of | Polystyrene (part) | | 100 | 100 |
| polystyrene, | Talc master batch (part) | | 0.2 | 0.2 |
| talc master | Flame | TBBA *2 (part) | 2.0 | 2.0 |
| batch, flame | retardant | TPP *3 (part) | 0.68 | 0.68 |
| retardant | Weight ratio TBBA/TPP | | 2.9 | 2.9 |
| and blowing | Blowing agent | Isobutane (mol/kg) | 0.29 | 0.26 |
| agent | | Ethanol (mol/kg) | 0.66 | — |
| | | Dimethyl ether | — | 0.61 |
| | | (mol/kg) | | |
| | | Carbon dioxide | 0.35 | 0.32 |
| | | (mol/kg) | | |
| | Proportion of | Isobutane (mol %) | 22 | 22 |
| | blowing agent | Ethanol (mol %) | 51 | — |
| | components | Dimethyl ether | — | 51 |
| | | (mol %) | | |
| | | Carbon dioxide | 27 | 27 |
| | | (mol %) | | |
| Properties | Apparent density (kg/m³) | | 32.7 | 36.8 |
| of extruded | Thickness (mm) | | 27 | 27 |
| foam boards | Closed cell content (%) | | 93 | 94 |
| | Average cell diameter in the | | 0.52 | 0.54 |
| | thickness direction (mm) | | | |
| | Cell strain rate | | 1.3 | 1.4 |
| | Thermal conductivity after 4 weeks | | 0.035 | 0.035 |
| | (W/m · K) | | | |
| | Flammability after 4 weeks | | B | A |
| | Extrusion moldability | | A | A |
| | Residual | Isobutane (mol/kg) | 0.25 | 0.22 |
| | amounts of | Ethanol (mol/kg) | 0.17 | — |
| | blowing agent | Dimethyl ether | — | 0 |
| | after 4 weeks | (mol/kg) | | |

*2: TBBA: 2,2-Bis(4-(2,3-dibromo-2-methylpropoxy)-3,5-dibromophenyl)propane
*3: TPP: Triphenyl phosphate

### EXAMPLE 8

An extruded foam board was prepared in the same manner as described in Example 1 except that the amount of the talc master batch was changed as shown in Table 3 and that the blowing agent was changed to a mixture of 1,1,1,2-tetrafluoroethane (HFC134a), isobutane and methyl chloride. The amounts of respective blowing agent components (HFC134a, isobutane and methyl chloride) per 1 kg of the polystyrene were as shown in Table 3. The apparent density, thickness, closed cell content, average cell diameter in the thickness direction, cell strain rate, thermal conductivity, flammability, extrusion moldability and residual amount of blowing agents of each of the thus obtained extruded foam boards are summarized in Table 3.

### EXAMPLES 9 AND 10 AND COMPARATIVE EXAMPLE 3

An extruded foam board was prepared in the same manner as described in Example 3 except that the amounts of respective flame retardant components were changed as shown in Table 3. The apparent density, thickness, closed cell content, average cell diameter in the thickness direction, cell strain rate, thermal conductivity, flammability, extrusion moldability and residual amount of blowing agents of the thus obtained extruded foam board are summarized in Table 3.

TABLE 3

| | | | | | | Comparative |
|---|---|---|---|---|---|---|
| | | | Example | | | Example |
| | | | 8 | 9 | 10 | 3 |
| Amounts of | Polystyrene (part) | | 100 | 100 | 100 | 100 |
| polystyrene, | Talc master batch (part) | | 0.5 | 4.2 | 4.2 | 4.2 |
| talc master | Flame retardant | TBBA *2 (part) | 1.4 | 2.5 | 3 | 0.2 |
| batch, flame | | TPP *3 (part) | 0.45 | 2.5 | 0.3 | 3 |
| retardant and | Weight ratio TBBA/TPP | | 3.1 | 1.0 | 10.0 | 0.1 |
| blowing agent | Blowing agent | HFC134a | 0.48 | — | — | — |
| | | Isobutane (mol/kg) | 0.24 | 0.58 | 0.58 | 0.58 |
| | | Methyl chloride | 0.48 | 0.47 | 0.47 | 0.47 |
| | | (mol/kg) | | | | |
| | Proportion of | HFC134a | 40 | — | — | — |
| | blowing agent | Isobutane (mol %) | 20 | 55 | 55 | 55 |
| | components | Methyl chloride | 40 | 45 | 45 | 45 |
| | | (mol %) | | | | |
| Properties | Apparent density (kg/m³) | | 34.9 | 37.1 | 37.7 | 37.8 |
| of extruded | Thickness (mm) | | 28 | 27 | 27 | 27 |
| foam boards | Closed cell content (%) | | 95 | 95 | 95 | 94 |
| | Average cell diameter in the | | 0.25 | 0.19 | 0.17 | 0.22 |
| | thickness direction (mm) | | | | | |
| | Cell strain rate | | 1.2 | 1.0 | 1.1 | 1.1 |
| | Thermal conductivity after 4 weeks | | 0.027 | 0.027 | 0.027 | 0.027 |
| | (W/m · K) | | | | | |
| | Flammability after 4 weeks | | A | A | A | C |
| | Extrusion moldability | | A | A | A | A |
| | Residual | HFC134a (mol/kg) | 0.45 | — | — | — |
| | amounts of | Isobutane (mol/kg) | 0.21 | 0.55 | 0.54 | 0.53 |
| | blowing agent | Methyl chloride | 0 | 0 | 0 | 0 |
| | after 4 weeks | (mol/kg) | | | | |

*2: TBBA: 2,2-Bis(4-(2,3-dibromo-2-methylpropoxy)-3,5-dibromophenyl)propane
*3: TPP: Triphenyl phosphate
*4: HFC134a: 1,1,1,2-tetrafluoroethane

The properties and method of evaluation of the foam boards shown in Tables 1 to 3 are as follows.

Apparent Density:

The apparent density is measured according to JIS K7222-1985.

Thickness:

The thickness is the arithmetic mean of the thicknesses measured at three positions at which the width of the extruded foam board is divided into equal quarters.

Average Cell Diameter in the Thickness Direction and Cell Strain Rate:

The average cell diameter in the thickness direction and the cell strain rate are measured according to the methods described previously.

Closed Cell Content:

The closed cell content is measured on a 25 mm×25 mm×20 mm specimen cut out from the extruded foam board and having no molded skin according to the method described previously.

Thermal Conductivity:

The foam board immediately after production is allowed to stand for 4 weeks in a room maintained at a temperature of 23° C. and a relative humidity of 50%. A specimen having a length of 20 cm, a width of 20 cm and a thickness of the extruded foam board is cut out from the resulting foam board. The thermal conductivity is measured by the plate type heat flow meter method (twin-plate type heat flowmeter, high temperature-side hot plate temperature: 35° C., low temperature-side hot plate temperature: 5° C., average temperature: 20° C.) described in JIS A1412-1994 according to Section 4.7 of JIS A9511-1995 using a thermal conductivity tester (AUTO A Model HC-73 manufactured by Eko Instruments Trading Co., Ltd.).

Flammability:

The foam board immediately after production is allowed to stand for 4 weeks in a room maintained at a temperature of 23° C. and a relative humidity of 50%. Five specimens are cut out from the resulting foam board (n=5). The flammability is measured according to Measuring Method A described in Section 4.13.1 of JIS A9511-1995 and is evaluated according to the following ratings:
A: The flame extinguishing time is no more than 3 seconds for all specimens and the average flame extinguishing time of 5 specimens is no more than 2 seconds.
B: The flame extinguishing time is no more than 3 seconds for all specimens and the average flame extinguishing time of 5 specimens is more than 2 seconds but no more than 3 seconds.
C: The average flame extinguishing time of 5 specimens is more than 3 seconds.
   Extrusion Moldability:

The foam board is observed with naked eyes and the moldability is evaluated according to the following ratings:
A: No voids are observed on its cross-section. The foam board has good appearance with no wrinkles or undulations being present on its surface. The foam board can be extruded in a stable manner.
B: Voids are observed on its cross-section. The foam board has poor appearance with wrinkles or undulations being present on its surface. The foam board cannot be extruded in a stable manner.
   Residual Amount of Blowing Agent:

The foam board immediately after production is allowed to stand for 4 weeks in a room maintained at a temperature of 23° C. and a relative humidity 50%. The residual amount of blowing agent (content of isobutane, methyl chloride, 1,1,1,2-tetrafluotoethane and dimethyl ether per 1 kg of the foam board) in the resulting foam board 4 weeks after the production is measured with Shimadzu Gas Chromatograph GC-14B manufactured by Shimadzu Corporation using cyclopentane as an internal standard substance. The measuring conditions of the gas chromatography are as follows.

Column: manufactured by Shinwa Chemical Industries, Ltd.; Silicone DC 550 (liquid phase quantity: 20%); column length: 4.1 m; column inside diameter: 3.2 mm

Support: Chromosorb W, AW-DMCS treated, mesh: 60-80

Column temperature: 40° C.

Inlet temperature: 200° C.

Carrier gas: nitrogen

Carrier gas velocity: 3.5 ml/min

Detector: FID

Detector temperature: 200° C.

Determination: internal standard method

The residual amount of the ethanol blowing agent (content of ethanol per 1 kg foam board) in the resulting foam board 4 weeks after the production is measured with Gas Chromatograph GC353B manufactured by GL Science Co., Ltd. by the absolute calibration method. The measuring conditions of the gas chromatography are as follows.

Capillary column: CP-PoraPLOT Q manufactured by VARIAN Inc.; made of fused silica; column length: 10 m, column inside diameter: 0.53 mm; stationary phase: 5% phenylmethylpolysiloxane 20 μm

Detector: FID

Detector (FID) temperature: 200° C,

Sample vial heating temperature: 170° C.

Sample vial heating time: 15 minutes

Carrier gas: helium 5 ml/min

Column oven temperature: 50° C.×5 min→10° C./min (15 min)→200° C.×10 min

In the above Examples and Comparative Examples, the thermal conductivity, flammability and residual amount of the blowing agent of the foam boards are tested 4 weeks after the production thereof, since some blowing agents such as methyl chloride, dimethyl ether, carbon dioxide and ethanol mostly escape relatively fast from the foam boards. Thus, before putting on the market, foam boards are generally aged to permit such easily permeable gases to escape therefrom so as to stabilize their heat insulation property and flammability. Although depending upon the kind thereof, such easily permeable gases can almost escape from the foam boards, when aged at 23° C. and 50% relative humidity for about 4 weeks. The heat insulation property and flammability of the foam boards are thus generally stabilized 4 weeks after production.

From the results summarized in Tables 1 to 3 above, the following points will be appreciated. Namely, the results of Examples 1 to 10 in which relatively thick extruded polystyrene resin foam boards having a low apparent density are produced using the specific combination of the flame retardant components according to the present invention, show that the foam boards are produced with excellent extrusion moldability and have good flame retardancy.

Examples 1 to 5 uses a blowing agent composition composed of isobutane and methyl chloride. Excellent flame retardancy is obtained in Examples 1 and 2, even though the amounts of the flame retardant components are relatively small. The heat insulation property is significantly improved in the foam boards of Examples 3 to 5, because a specific amount of isobutane remains present therein. It will be also noted that the flame retardancy is,high even though the residual amount of isobutane which is highly flammable is high.

Comparative Example 1 which is to be compared with Examples 1 and 2 uses the flame retardant components in amounts smaller than the lower limits required in the present invention. Although the moldability and thermal conductivity of the foam board of Comparative Example 1 pose no problems, the flame retardancy thereof is unsatisfactory.

Comparative Example 2 which is to be compared with Examples 1 and 2 uses the flame retardant component in an amount greater than the upper limit required in the present invention. As a consequence, the variation of the extrusion pressure is so great that the extrusion was unable to be conducted in a stable manner and, hence, an extruded foam board was unable to be produced.

Example 6 uses a blowing agent composition composed of isobutane, ethanol and carbon dioxide, while Example 7 uses a blowing agent composition composed of isobutane, dimethyl ether and carbon dioxide. The foam board of Example 6 which contains a small amount of ethanol shows satisfactory flame retardancy. The foam board of Example 7 also shows good flame retardancy.

Example 8 uses a blowing agent composition composed of 1,1, 1, 2-tetrafluoroethane, isobutane and methyl chloride. For the purpose of obtaining high flame retardancy for an especially long period of time, 1,1,1,2-tetrafluoroethane is used. In fact, high flame retardancy is obtained. It will be also noted that the flame retardancy is high even though the highly flammable blowing agent is used.

Examples 9 and 10 use a blowing agent composition composed of isobutane and methyl chloride. The heat insulation property is significantly improved in the foam boards, because a specific amount of isobutane remains present therein. It will be also noted that the flame retardancy is high even though the residual amount of isobutane which is highly flammable is high.

Comparative Example 3 which is to be compared with Example 3 uses the brominated bisphenol ether in an amount smaller than the lower limit required in the present invention. Although the extrusion moldability and thermal conductivity of the foam board do not pose problems, the flame retardancy thereof is unsatisfactory.

What is claimed is:

1. A process for preparing an extruded polystyrene resin foam board having an apparent density of 20 to 60 kg/m³ and a thickness of 10 to 150 mm, comprising extruding a foamable composition, which contains at least a polystyrene resin, a flame retardant and a blowing agent and which has been molten and kneaded in an extruder, through a die attached to said extruder,
wherein said flame retardant comprises a phosphate ester and a brominated bisphenol ether compound represented by the following formula: 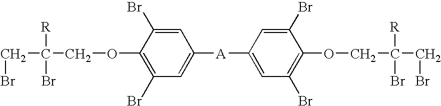
where R represents an alkyl group having 1 to 3 carbon atoms and A represents —C(CH₃)₂—, —SO₂—, —S—, —O—, —CO— or —CH₂—, and
wherein said phosphate ester and said brominated bisphenol ether compound are present in amounts of 0.1 to 6 parts by weight and 0.5 to 5 parts by weight, respectively, per 100 parts by weight of said polystyrene resin.

2. A process as claimed in claim 1, wherein the weight ratio of said brominated bisphenol ether compound to said phosphate ester is in the range of 0.3 to 30.

3. A process as claimed in claim 1, wherein said brominated bisphenol ether compound is at least one compound selected from the group consisting of 2,2-bis[4-(2,3-dibromo-2-methylpropoxy)-3,5-dibromophenyl]propane, bis[4-(2,3-dibromo-2-methylpropoxy)-3,5-dibromophenyl]sulfone, bis[4-(2,3-dibromo-2-methylpropoxy)-3,5-dibromophenyl]sulfide and bis[4-(2,3-dibromo-2-methylpropoxy)-3,5-dibromophenyl]methane.

4. A process as claimed in claim 1, wherein said brominated bisphenol ether compound is 2,2-bis[4-(2,3-dibromo-2-methylpropoxy)-3,5-dibromophenyl]propane.

5. A process as claimed in claim 1, wherein said phosphate ester is at least one compound selected from the group consisting of trimethyl phosphate, triethyl phosphate, tributyl phosphate, trioctyl phosphate, tris(2-ethylhexyl) phosphate, tris(butoxyethyl) phosphate, octyldiphenyl phosphate, triphenyl phosphate, tricresyl phosphate, trixylyl phosphate, cresyldiphenyl phosphate, 2-ethylhexyldiphenyl phosphate, cresyldi-2,6-xylyl phosphate, resolcinol bis(diphenyl phosphate) and bisphenol A bis(diphenyl phosphate).

6. A process as claimed in claim 1, wherein said phosphate ester is triphenyl phosphate.

7. A process as claimed in claim 1, wherein said blowing agent comprises (a) 10 to 80 mol % of a saturated hydrocarbon having 3 to 5 carbon atoms and (b) 90 to 20 mol % of at least one compound selected from the group consisting of methyl chloride, ethyl chloride, dimethyl ether, diethyl ether, methyl ethyl ether, methanol, ethanol, water and carbon dioxide, wherein a total of (a) and (b) is 100 mol %.

8. A process as claimed in claim 1, wherein said blowing agent comprises (a) 5 to 70 mol % of a saturated hydrocarbon having 3 to 5 carbon atoms, (b) 10 to 90mol % of at least one compound selected from the group consisting of methyl chloride, ethyl chloride, dimethyl ether, diethyl ether, methyl ethyl ether, methanol, ethanol, water and carbon dioxide and (c) 0 to 70 mol % of 1,1,1,2-tetrafluoroethane, wherein a total of (a), (b) and (c) is 100 mol %.

9. An extruded polystyrene resin foam board having an apparent density of 20 to 60 kg/m³ and a thickness of 10 to 150 mm and containing 0.10 to 0.90 mol of a saturated hydrocarbon having 3 to 5 carbon atoms per 1 kg of said foam board and a flame retardant comprising a phosphate ester and a brominated bisphenol ether compound represented by the following formula: 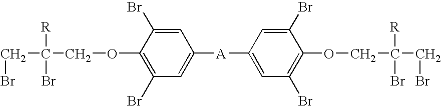
wherein R represents an alkyl group having 1 to 3 carbon atoms and A represents —C(CH₃)₂—, —SO₂—, —S—, —O—, —CO— or —CH₂—.

10. The foam board as claimed in claim 9, wherein said brominated bisphenol ether compound is at least one compound selected from the group consisting of 2,2-bis[4-(2,3-dibromo-2-methylpropoxy)-3,5-dibromophenyl]propane, bis[4-(2,3-dibromo-2-methylpropoxy)-3,5-dibromophenyl]sulfone, bis[4-(2,3-dibromo-2-methylpropoxy)-3,5-dibromophenyl]sulfide and bis[4-(2,3-dibromo-2-methylpropoxy)-3,5-dibromophenyl]methane.

11. The foam board as claimed in claim 9, wherein said brominated bisphenol ether compound is 2,2-bis[4-(2,3-dibromo-2-methylpropoxy)-3,5-dibromophenyl]propane.

12. The foam board as claimed in claim 9, wherein said phosphate ester is at least one compound selected from the group consisting of trimethyl phosphate, triethyl phosphate, tributyl phosphate, trioctyl phosphate, tris(2-ethylhexyl) phosphate, tris(butoxyethyl) phosphate, octyldiphenyl phosphate, triphenyl phosphate, tricresyl phosphate, trixylyl phosphate, cresyldiphenyl phosphate, 2-ethylhexyldiphenyl phosphate, cresyldi-2,6-xylyl phosphate, resolcinol bis(diphenyl phosphate) and bisphenol A bis(diphenyl phosphate).

13. The foam board as claimed in claim 9, wherein said phosphate ester is triphenyl phosphate.

14. An extruded polystyrene resin foam board having an apparent density of 20 to 60 kg/m³ and a thickness of 10 to 150 mm and containing 0 to 0.80 mol of 1,1,1,2-tetrafluoroethane per 1 kg of said foam board, 0.05 to 0.80 mol of a saturated hydrocarbon having 3 to 5 carbon atoms per 1 kg of said foam board and a flame retardant comprising a phosphate ester and a brominated bisphenol ether compound represented by the following formula: 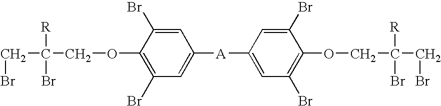
wherein R represents an alkyl group having 1 to 3 carbon atoms and A represents —C(CH₃)₂—, —SO₂—, —S—, —O—, —CO— or —CH₂—.

15. The foam board as claimed in claim 14, wherein said brominated bisphenol ether compound is at least one compound selected from the group consisting of 2,2-bis[4-(2,3-dibromo-2-methylpropoxy)-3,5-dibromophenyl]propane, bis[4-(2,3-dibromo-2-methylpropoxy)-3,5-dibromophenyl]sulfone, bis[4-(2,3-dibromo-2-methylpropoxy)-3,5-dibromophenyl]sulfide and bis[4-(2,3-dibromo-2-methylpropoxy)-3,5-dibromophenyl]methane.

16. The foam board as claimed in claim 14, wherein said brominated bisphenol ether compound is 2,2-bis[4-(2,3-dibromo-2-methylpropoxy)-3,5-dibromophenyl]propane.

17. The foam board as claimed in claim 14, wherein said phosphate ester is at least one compound selected from the group consisting of trimethyl phosphate, triethyl phosphate, tributyl phosphate, trioctyl phosphate, tris(2-ethylhexyl) phosphate, tris(butoxyethyl) phosphate, octyldiphenyl phosphate, triphenyl phosphate, tricresyl phosphate, trixylyl phosphate, cresyldiphenyl phosphate, 2-ethylhexyldiphenyl phosphate, cresyldi-2,6-xylyl phosphate, resolcinol bis(diphenyl phosphate) and bisphenol A bis(diphenyl phosphate).

18. The foam board as claimed in claim 14, wherein said phosphate ester is triphenyl phosphate.
